(19) United States
(12) Patent Application Publication
(10) Pub. No.: US 2019/0360404 A1
(43) Pub. Date: Nov. 28, 2019

(54) GAS TURBINE ENGINE

(71) Applicant: Rolls-Royce Deutschland Ltd & Co KG, Blankenfelde-Mahlow (DE)

(72) Inventor: Andreas STAUDTE, Berlin (DE)

(21) Appl. No.: 16/413,086

(22) Filed: May 15, 2019

(30) Foreign Application Priority Data
May 22, 2018 (DE) 10 2018 112 244.6

(51) Int. Cl. F02C 7/32; F02C 9/18

(52) U.S. Cl. CPC F02C 7/32; F05D 2220/323; F02C 9/18

(57) ABSTRACT

A gas turbine engine for an aircraft having a core flow channel is described. Compressed air from the core flow channel can be conducted via a line through a core region radially outward into an outer jacket region. The core region is arranged radially at the outside on the core flow channel and is separated therefrom. The core region and the jacket region are separated from one another by a wall. The line is led sealingly through the wall. That part of the line which runs through the core region is completely surrounded by a further line. The lines delimit a gap space which extends in an axial direction and in a circumferential direction of the lines. The gap space is operatively connected to the jacket region and is sealed off with respect to the core region.

This application claims priority to German Patent Application DE102018112244.6 filed May 22, 2018, the entirety of which is incorporated by reference herein.

The present disclosure relates to a gas turbine engine for an aircraft.

Aircraft are commonly equipped in each case with a so-called environmental control system (ECS) which comprises substantially three system components in order, inter alia in a cabin, to be able to perform pressure and temperature control and exchange the air contained therein. For the operation of an ECS of said type, during flight, compressed air is commonly provided by a gas turbine engine. So-called bleed air from the compressor of a gas turbine engine is utilized for this purpose. The bleed air may be at a temperature of up to 400° C. and, depending on the extraction point, has a positive pressure of several bar in relation to the ambient pressure of the gas turbine engine. The bleed air is extracted from a core flow channel of the gas turbine engine upstream of the point at which the air flow conducted through a core flow channel enters a combustion chamber.

Irrespective of whether the bleed air of a jet engine or of a turboprop engine is used, the bleed air is introduced from the core flow channel into a line and, in the line, is guided through a core region which adjoins the core flow channel radially at the outside and which is separated from the core flow channel. The core region adjoins a radially outer jacket region of the gas turbine engine, wherein the core region extends via a panelling, which extends through a bypass flow channel in a radial direction, to the jacket region. Between the core region and the jacket region, there is provided a wall or a partition through which the line is sealingly guided. From the partition, the line leads to a connection point of the gas turbine engine to the aircraft, in the region of which the bleed air is transferred to the aircraft.

Leaks of the line give rise, under some circumstances, to not inconsiderable thermal loading and pressure loading of the core region and of the jacket region and of components, arranged therein in each case, of a gas turbine engine, which can undesirably impair the function of the gas turbine engine.

For this reason, a temperature and/or a pressure in the core region and in the jacket region are monitored by means of suitable detection units. Since the flow path of the bleed air runs both through the core region and through the jacket region of a gas turbine engine, separate detection units are required for these regions, which however results in high outlay in terms of apparatus.

EP 3 078 811 A1 has disclosed an aircraft engine having a protection system. Here, a line is surrounded in regions by a housing, wherein the housing and the line delimit a gap space. The housing comprises at least one fluid outlet means through which fluid entering the gap space from a leak of the line can flow out of the gap space in the direction of surroundings of the line and of the housing and is at the same time defined and limited in terms of its maximum leakage rate by the defined gap space.

It is sought to provide a gas turbine engine in the case of which a functional failure of a line for bleed air can be detected in a simple manner.

This object is achieved by a gas turbine engine having the features of Patent Claim 1.

According to a first aspect, a gas turbine engine for an aircraft having a core flow channel is provided. Compressed air from the core flow channel can be conducted via a line through a core region, which is arranged radially at the outside on the core flow channel and is separated therefrom, radially outward into an outer jacket region. The core region and the jacket region are separated from one another by a wall. The line is led sealingly through the wall. That part of the line which runs through the core region is completely surrounded by an outer line. The lines delimit a gap space which extends in an axial direction and in a circumferential direction of the lines. The gap space is sealed off with respect to the core region and is connected to the jacket region.

The gap space, which is sealed off with respect to the core region and is connected to the jacket region, constitutes a so-called evacuation region, via which bleed air that emerges from the line in the event of a leak of the line in the core region can be introduced into the jacket region. In this way, it is achieved that compressed air that emerges from a leak of the line in the core region does not enter the core region, but is rather captured by the outer line and introduced through the gap space into the jacket region.

In this way, pressures and temperatures which result from a leak of the line both in the core region and in the jacket region and which impair a function of the gas turbine engine can be determined by means of a detection unit, which is arranged for example in the jacket region, and corresponding countermeasures, such as the shut-down of the gas turbine engine, can be initiated within short operating times.

Furthermore, by means of the discharge of the compressed air emerging from the line in the core region into the gap space, which compressed air is under certain circumstances also at high temperatures, an undesired pressure increase and uncontrolled heating of the core region can be prevented in a simple manner in terms of construction.

In an embodiment of the gas turbine engine which is simple in terms of construction, the gap space is sealed off with respect to the core region by means of a seal which is arranged between an outer side of the line and an inner side of the further or outer line.

In a further embodiment of the gas turbine engine, an admission of compressed air emerging from the line into the core region is prevented by virtue of the gap space being sealed off with respect to the core region by means of a seal, which acts between the inner side or an outer side of the further line and the wall.

In a further embodiment of the gas turbine engine, the line is led through the wall by means of a fitting which is connected to the wall. Here, the further line is operatively connected to the fitting and, together with the fitting, seals off the gap space with respect to the core region. Additionally, the fitting, together with the line, seals off a further gap space via which the gap space is connected to the jacket region.

If the wall is of fireproof design, an undesired propagation of a fire that has broken out in the core region or in the jacket region to the jacket region or to the core region can be prevented in a simple manner.

In an inexpensive embodiment of the gas turbine engine which is simple in terms of construction, the lines are designed as pipes.

In a further embodiment of the gas turbine engine, the line has, in the core region, a flexible bellows which is engaged around by the further line and arranged within the gap space. Such a flexible bellows has the effect, for example, of a universal joint. It is thus possible for different expansion behavior between walls, which delimit the core region and the jacket region, of the gas turbine engine to be compensated without distortion states being caused in the line.

If the further line has a flexible bellows in the core region, distortion states and the further line caused by different expansion behavior between the core region and the jacket region can also be avoided with little outlay.

Furthermore, between the outer side of the line and the inner side of the further line, in the gap space, there may be arranged at least one spacer which acts in a radial direction and which is formed with at least one passage opening. In this way, it is in turn ensured that the flow cross section of the gap space is available over the entire operating range of the gas turbine engine and, for example, abutment of the line and of the further line against one another owing to vibrations is prevented.

If, in the jacket region, there is provided a detection unit by means of which a temperature and/or a pressure in the jacket region are/is determinable, operating states in the jacket region which result from a leak of the line and which have an adverse effect on the operating behavior of the gas turbine engine can be determined with little outlay in terms of apparatus.

It is self-evident to a person skilled in the art that a feature or parameter described above in relation to one of the above aspects can be applied to any other aspect, unless these are mutually exclusive. Furthermore, any feature or any parameter described here may be applied to any aspect and/or combined with any other feature or parameter described here, unless these are mutually exclusive.

Embodiments will now be described, merely by way of example, with reference to the figures.

In the figures:

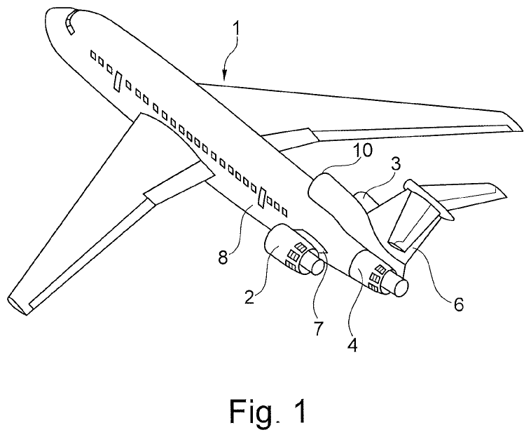

FIG. 1 shows a simplified three-dimensional view of an aircraft with jet engines arranged in the rear region on an aircraft fuselage;

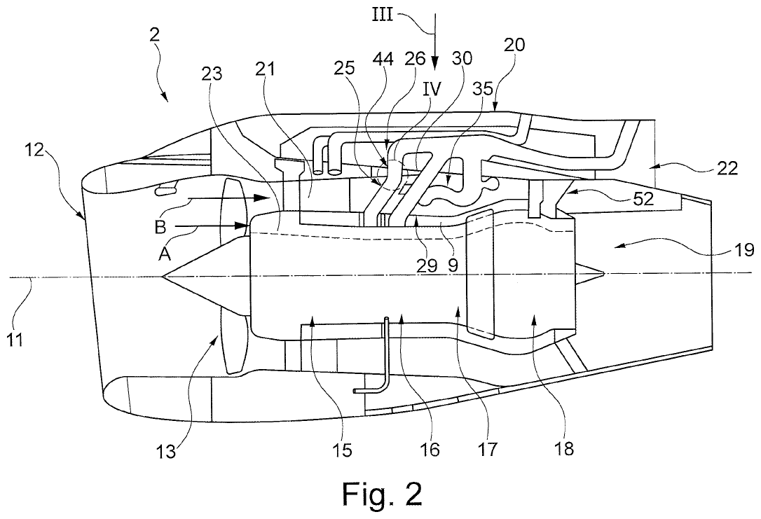

FIG. 2 shows a simplified longitudinal sectional view of a gas turbine engine of the aircraft as per FIG. 1;

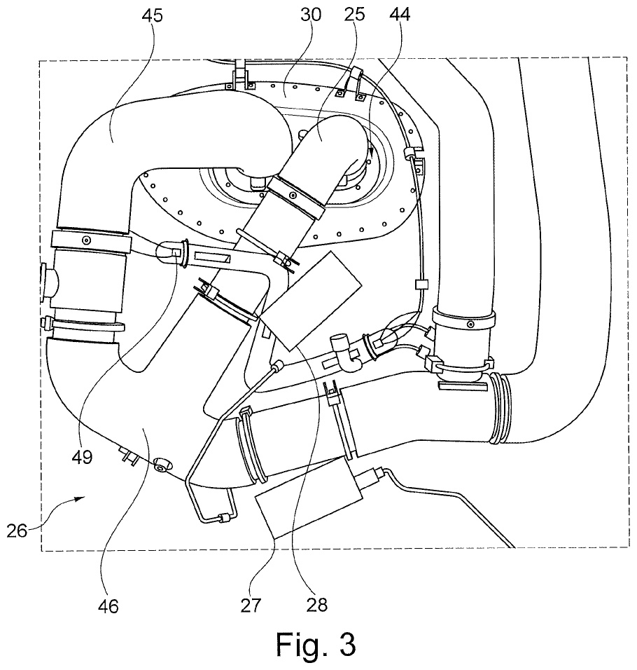

FIG. 3 shows a simplified three-dimensional exterior view of a region of the gas turbine engine as per FIG. 2; and

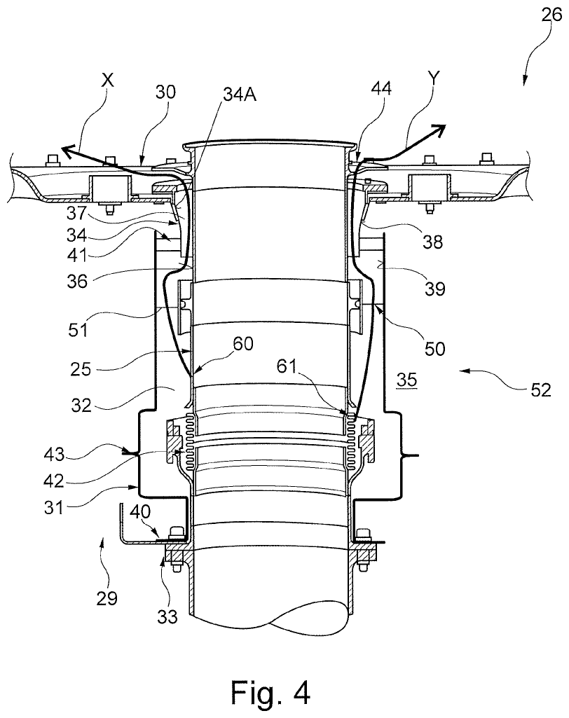

FIG. 4 shows an enlarged cross-sectional illustration of a region IV of the gas turbine engine as per FIG. 2.

FIG. 1 shows a passenger aircraft or an aircraft 1 which can be propelled by three jet engines or gas turbine engines 2, 3, 4. The first gas turbine engine 2 is arranged on a left-hand side of the aircraft in the rear region of the aircraft 1, in the region of a vertical stabilizer 6, and is attached in the region of an engine pylon 7 to an aircraft fuselage 8. The second gas turbine engine 3 is connected to the aircraft fuselage 8 substantially mirror-symmetrically on a right-hand side of the aircraft.

The third gas turbine engine 4 is positioned at the rear end of the aircraft fuselage 8 and is attached to an inner fuselage strut, which is arranged below the vertical stabilizer 6 of the aircraft 1. For the feed of air to the third gas turbine engine 4, an air inlet opening 10 is provided which is arranged, in front of the vertical stabilizer 6 in a direction of flight, on a top side of the aircraft fuselage 8 and which is connected, within the aircraft fuselage 8, to the third gas turbine engine 4.

Numerous arrangements of jet engines on an aircraft are basically possible, wherein a jet engine or a gas turbine engine may for example also, aside from the positions shown, be arranged in the region of an aircraft wing, below or above the latter.

FIG. 2 illustrates the gas turbine engine 2 with a main axis of rotation 11. The gas turbine engine 2 comprises an air inlet 12 and a fan 13, which in the present case constitutes a low-pressure compressor and which generates two air flows: a core air flow A and a bypass air flow B. The gas turbine engine 2 has a core flow channel 23 which receives the core air flow A. The core flow channel 23 comprises, in an axial direction proceeding from the air inlet 12, a high-pressure compressor 15, a combustion chamber 16, a high-pressure turbine 17, a low-pressure turbine 18 and a core thrust nozzle 19. An engine nacelle 20 surrounds the gas turbine engine 2 and defines a bypass flow channel 21 or bypass channel and a bypass thrust nozzle 22. The bypass air flow B flows through the bypass channel 21. The fan 13 may be attached by means of a shaft (not illustrated in any more detail) and an epicyclic transmission to the low-pressure turbine 18 and driven by the latter. Here, the shaft is also referred to as core shaft.

A dedicated nozzle is thus provided for the bypass air flow B, which nozzle is separate from and radially to the outside of the core thrust nozzle 19. This is however not limiting, and any aspect of the present disclosure may also apply to engines in which the bypass air flow through the bypass flow channel 21 and the core air flow through the core air channel 23 are mixed or combined before (or upstream of) a single nozzle, which may be referred to as a mixed flow nozzle. One or both nozzles (whether mixed or split flow) may have a fixed or variable area.

During the use of the gas turbine engine 2, the core air flow A is accelerated and compressed by the low-pressure compressor 14 and introduced into the high-pressure compressor 15, where further compression takes place. The compressed air discharged from the high-pressure compressor 15 is directed into the combustion chamber 16, where it is mixed with fuel and the mixture is combusted. The resultant hot combustion products then expand through, and thereby drive, the high-pressure and low-pressure turbines 17, 18 before being discharged through the core thrust nozzle 19 in order to provide a certain thrust force. The high-pressure turbine 17 drives the high-pressure compressor 15 by means of a suitable connecting shaft, which is also referred to as core shaft. The fan 13 generally provides the majority of the thrust force. The epicyclic transmission may be a speed-reduction transmission.

In general, a gas turbine engine is composed at least of a shaft, via which a compressor and a turbine are connected to one another. If further compressors and turbines are provided, these are coupled to one another by means of further shafts. For example, it is thus possible for a gas turbine engine to comprise three shafts, which are referred to as low-pressure, medium-pressure and high-pressure shafts. The gas turbine engine 2 illustrated in the drawing is a so-called turbojet engine, in which the lowest compression stage is the fan 13, wherein a part of the air stream compressed by the fan is conducted as bypass air flow A through the bypass flow channel 21.

Other gas turbine engines to which the present disclosure may be applied may have alternative configurations. For example, such engines may have an alternative number of compressors and/or turbines and/or an alternative number of connecting shafts. Whilst the described example relates to a turbofan engine, the disclosure may apply, for example, to any type of gas turbine engine, such as an open-rotor (in which the fan stage is not surrounded by an engine nacelle) or turboprop engine, for example.

The geometry of the gas turbine engine 2, and components thereof, is or are defined using a conventional axis system which comprise an axial direction (which is aligned with the main axis of rotation 11), a radial direction (in the direction from bottom to top in FIG. 2), and a circumferential direction (perpendicular to the view in FIG. 2). The axial direction, the radial direction and the circumferential direction run perpendicular to one another.

To be able to supply air to the aircraft 1 as desired and to additionally permit temperature control and cabin pressurization for passengers and crew, the aircraft 1 is equipped with a so-called environmental control system (ECS). So-called avionics cooling, smoke detection and fire suppression can also be realized by means of the ECS.

In the aircraft 1, compressed air from the gas turbine engines 2 to 4 is fed to the ECS. For this purpose, the so-called bleed air is extracted from the high-pressure compressor 15 upstream of the combustion chamber 16. The temperature and the pressure of this bleed air vary greatly in a manner dependent on the compressor stage and the rotational speed of the gas turbine engine 2, 3 or 4.

In the present case, the bleed air is introduced via a line 25 from the core flow channel 23 and through a core region 29, and through a jacket region 26 delimited by the engine nacelle 20, to the engine pylon 7, and from there into the aircraft fuselage 8. Here, in addition to a cavity 9 running radially between the core flow channel 23 and the bypass flow channel 21, the core region 29 also comprises an interior space 35 of a supply channel 52 which runs radially through the bypass flow channel 21.

A so-called manifold pressure regulating shut-off valve 27 schematically illustrated in FIG. 3 limits the throughflow as required in order to maintain the desired pressure for downstream systems. When the gas turbine engines 2 to 4 are delivering a low level of thrust, the bleed air is drawn from a so-called high-pressure stage. If the thrust is increased, the pressure of the high-pressure stage increases to the changeover point at which a so-called high-pressure shut-off valve 28 closes, and air is thereafter drawn off from a so-called low-pressure stage.

To attain the desired cabin temperature, the bleed air is connected through a heat exchanger, which is also referred to as pre-cooler. The air from the fan 13 of the gas turbine engine 2, 3 or 4 is blown via the pre-cooler, which is preferably situated in the engine strut. A so-called fan air modulating valve varies the cooling air flow and thus controls the final air temperature of the bleed air.

A so-called cold air unit, or unit also referred to as air conditioning pack, of the ECS normally constitutes a cooling device for air circuit machines. In the case of most aircraft, the air-conditioning packs are situated in the so-called wing to body faring between the wings under the fuselage. In the case of the aircraft 1 considered here, the air-conditioning packs are arranged in the rear end.

The quantity of bleed air that is introduced via the line 25 into the air conditioning packs is controlled by a so-called flow control valve (FCV). Here, in each case at least one FCV is installed for each air-conditioning pack.

FIG. 4 shows an enlarged cross-sectional view of a region IV which is indicated more closely in FIG. 2 and in which the line 25 runs from the core flow channel 23 through the core region 29, which adjoins the core flow channel 23 radially at the outside, and through a fireproof wall 30 into the jacket region 26. Through the line 25, compressed air or bleed air can be conducted through the core region 29 radially outward into the outer jacket region 26. In the present case, the wall 30 is arranged between the core region 29 and the jacket region 26 and separates these from one another. Furthermore, the line 25 is led sealingly through the wall 30. Additionally, a part of the line 25 which runs through the core region 29 is completely surrounded by a further line 31.

The lines 25 and 31 delimit a gap space 32 which extends in an axial direction and in a circumferential direction of the lines 25 and 31. The gap space 32 is sealed off with respect to the core region 29. Additionally, the gap space 32 is connected to the jacket region 26. At one end, the further or outer line 31 is screwed by means of a flange 33 to the line 25, wherein, in this region, there is provided a seal 40 for sealing off the gap space 32 with respect to the core region 29. Additionally, the line 25 is led through a fitting 34 which is connected fixedly to the wall 30 and the inner side 34A of which is radially spaced apart from an outer side 36 of the line 25 and, together with the line 25, delimits a further gap space 37.

At the other end, between an outer side 38 of the connector 34 and an inner side 39 of the further line 31, there is likewise provided a seal 41 by means of which the gap space 32 and also the further gap space 37 are sealed off with respect to the core region 29. Both the line 25 and the further line 31 are in the present case each formed with a flexible bellows 42 and 43 respectively, by means of which, in each case, a different thermal expansion behavior of those devices of the gas turbine engine 2 which delimit the core region 29 and of the wall 30 can be compensated without distortion being generated in the lines 25 and 31.

Additionally, between the outer side 36 of the line 25 and the inner side 39 of the further line 31, in the gap space 32, there is arranged a spacer 50 which acts in a radial direction and which is formed with multiple passage openings 51. By means of the passage openings 51 of the spacer 50, it is ensured that the gap space 32 is operatively connected as desired to the jacket region 26 in order to be able to suitably ensure an exchange of air between the gap space 32 and the jacket region 26, corresponding to the profiles X and Y indicated by way of example, proceeding from a leak 60 or 61 of the line 25.

Furthermore, FIG. 3 shows a part of the jacket region 26 from a direction Ill shown more closely in FIG. 2. Here, FIG. 3 illustrates a part of the line 25 proceeding from the passage region 44 of the line 25 through the wall 30. Aside from the line 25, an additional line 45 is illustrated, by means of which it is likewise possible for bleed air to be conducted out of the core flow channel 23 in the direction of the engine pylon 7. The bleed air flows conducted through the two lines 25 and 45 are merged in the region of a manifold pipe 46. Upstream of the manifold pipe 46, the line 25 is formed with the high-pressure shut-off valve 28, by means of which the line 25 can be shut off. Additionally, downstream of the manifold pipe 46, there is arranged the manifold pressure regulating shut-off valve 27, by means of which the throughflow through the manifold pipe 46 can be limited as required.

Furthermore, in the jacket region 26, there is provided a detection unit 49, by means of which both the pressure and the temperature can be determined in the jacket region 26.

By means of the above-described design of the gas turbine engine 2, it is now possible by means of the detection unit 49 arranged in the jacket region 26 to monitor or detect both a malfunction of the line 25 in the core region 29 and in the jacket region 26. This results from the fact that leaks in that portion of the line 25 which runs in the core region 29 give rise to a bleed air volume flow emerging from the line 25, which initially flows into the gap space 32. This bleed air volume flow then flows via the further gap space 37 between the connector 34 and the further line 31 into the jacket region 26.

If the bleed air conducted in the line 25 is at a higher pressure level and/or a higher temperature level than the pressure and/or the temperature in the jacket region 26, a leakage in the line 25 gives rise to an increase of the pressure and/or of the temperature in the jacket region 26, which can then be determined in each case with little outlay in terms of apparatus by means of the detection unit 49.

### LIST OF REFERENCE DESIGNATIONS

1 Aircraft
2 to 4 Gas turbine engine
6 Stabilizer
7 Engine pylon
8 Aircraft fuselage
9 Cavity
10 Air inlet opening
11 Main axis of rotation
12 Air inlet
13 Fans
14 Low-pressure compressor
15 High-pressure compressor
16 Combustion chamber
17 High-pressure turbine
18 Low-pressure turbine
19 Core thrust nozzle
20 Engine nacelle
21 Bypass flow channel or bypass channel
22 Bypass thrust nozzle
23 Core flow channel
25 Line
26 Jacket region
27 Manifold pressure regulating shut-off valve
28 High-pressure shut-off valve
29 Core region
30 Wall
31 Further line
32 Gap space
33 Flange
34 Neck
34A Inner side of the fitting
35 Interior space of the supply channel
36 Outer side of the line
37 Further gap space
38 Outer side of the fitting
39 Inner side of the further line
40 Seal in the region of the flange
41 Seal in the region of the fitting
42 Bellows of the line
43 Bellows of the further line
44 Passage region of the wall
45 Additional line
46 Manifold pipe
49 Detection unit
50 Spacer
51 Passage opening
52 Supply channel
60, 61 Leakage of the line
A Core air flow
B Bypass air flow
X, Y Profile

1. A gas turbine engine for an aircraft, having a core flow channel, wherein compressed air from the core flow channel can be conducted via a line through a core region radially outward into an outer jacket region, wherein the core region is arranged radially at the outside on the core flow channel and is separated therefrom, wherein the core region and the jacket region are separated from one another by a wall, and the line is led sealingly through the wall, wherein that part of the line which runs through the core region is completely surrounded by a further line, and the lines delimit a gap space which extends in an axial direction and in a circumferential direction of the lines, and wherein the gap space is sealed off with respect to the core region and is connected to the jacket region.

2. The gas turbine engine according to claim 1, wherein the gap space is sealed off with respect to the core region by means of a seal which is arranged between an outer side of the line and an inner side of the further line.

3. The gas turbine engine according to claim 2, wherein the gap space is sealed off with respect to the core region by means of a seal which acts between the inner side or an outer side of the further line and the wall.

4. The gas turbine engine according to claim 1, wherein the line is led through the wall by means of a fitting which is connected to the wall, to which fitting the further line is operatively connected so as to seal off the gap space with respect to the core region and which fitting delimits, with the line, a further gap space via which the gap space is connected to the jacket region.

5. The gas turbine engine according to claim 1, wherein the wall is of fireproof design.

6. The gas turbine engine according to claim 1, wherein the lines are designed as pipes.

7. The gas turbine engine according to claim 1, wherein the line has, in the core region, a flexible bellows which is engaged around by the further line and arranged within the gap space.

8. The gas turbine engine according to claim 1, wherein the further line has a flexible bellows in the core region.

9. The gas turbine engine according to claim 2, wherein, between the outer side of the line and the inner side of the further line, in the gap space, there is arranged at least one spacer which acts in a radial direction and which is formed with at least one passage opening.

10. The gas turbine engine according to claim 1, wherein, in the jacket region, there is provided a detection unit by means of which a temperature and/or a pressure in the jacket region are/is determinable.
